(19) United States
(12) Patent Application Publication
(10) Pub. No.: US 2013/0054405 A1
(43) Pub. Date: Feb. 28, 2013

(54) NEGOTIATION FUNCTION BETWEEN BIDDER AND SELLER IN A TRADITIONAL LIVE AUCTION

(71) Applicant: XCIRA, INC, Tampa, FL (US)

(72) Inventors: Nancy J. Rabenold, Brandon, FL (US); James A. Simmons, Brandon, FL (US)

(73) Assignee: XCIRA, INC, Tampa, FL (US)

(21) Appl. No.: 13/663,455

(22) Filed: Oct. 29, 2012

Related U.S. Application Data
(63) Continuation of application No. 10/397,600, filed on Mar. 26, 2003, now Pat. No. 8,326,691.
Application No. 10/397,600 is a continuation-in-part of application No. 12/685,647, filed on Jan. 11, 2010.
Application No. 12/685,647 is a continuation of application No. 11/164,796, filed on Dec. 6, 2005, now Pat. No. 7,664,677.
Application No. 11/164,796 is a continuation-in-part of application No. 10/913,886, filed on Aug. 6, 2004, now Pat. No. 7,716,090.
Application No. 10/913,886 is a continuation of application No. 09/866,191, filed on May 25, 2001, now Pat. No. 6,813,612.
(60) Provisional application No. 60/367,557, filed on Mar. 26, 2002.
(60) Provisional application No. 60/207,030, filed on May 25, 2000.

(51) Int. Cl. G06Q 30/08

(52) U.S. Cl. 705/26.3

(57) ABSTRACT

Upon the conclusion of the bidding activity for an item that is being auctioned at a live auction and that includes an on-line audience and bidders, a negotiation function can be enabled between the high bidder and a seller/consignor or representative of the seller/consignor. The high bidder and seller can present counter offers until either landing on an acceptable arrangement or, concluding the negotiation process all together. In the mean time, the auction can proceed to the next item to be auctioned.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, is a continuation of U.S. application Ser. No. 10/397,600 filed on Mar. 26, 2003, which application claims the benefit of the filing date of U.S. Provisional Application for Patent Ser. No. 60/367,557 filed on Mar. 26, 2002.

This application is a continuation-in-part of U.S. patent application Ser. No. 12/685,647 filed on Jan. 11, 2010, which application is a continuation of U.S. Pat. No. 11/164,796 filed on Dec. 6, 2005 now U.S. Pat. No. 7,664,677, which is a continuation-in-part of U.S. patent application Ser. No. 10/913,886 filed on Aug. 6, 2004 now U.S. Pat. No. 7,716,090, which is a continuation of U.S. patent application Ser. No. 09/866,191 filed on May 25, 2001 and issued as U.S. Pat. No. 6,813,612 on Nov. 2, 2004, which claims benefit of the filing date of U.S. provisional application for patent having been assigned Ser. No. 60/207,030, and filed on May 25, 2000. Each of the above applications and patents are hereby incorporated by reference in their entirety.

### BACKGROUND

The traditional auction industry, especially that of professional dealers or wholesalers, is a very rapid pace event in which time is money for the auctioneer, auction company, consignor as well as the dealer or buyer/bidder. Many types of auctions use a “reserve price” scenario. If the item to be auctioned meets the specified price set by the consignor, the item is sold at that price, or higher. If the high bid does not meet the reserve price, then the consignor has the option of selling the item at the high bid, the bidder has the option of meeting the reserve price, or the consignor and bidder can negotiate a price. Currently, all negotiations are done by consignors sending a representative to the live auction block, or are done by telephone at the initiative of the live auction, and typically occur at a much later time (i.e., after the auction). With the increasing utilization of technology in the auction environment, it is desirable to provide the technological capability for both a bidder and a consignor, whether they are local or remote, to negotiate during the bidding process, instantaneously, and without disrupting the live auction flow. This capability is essential to providing immediate feedback to both the bidder and the consignor as a price negotiation is conducted.

If the consignor has met his or her overall objectives for the auction sale, the consignor may be willing to sell any item at a much lower price than the reserve price in order to reduce inventory and carrying costs. If a bidder needs that specific item to complete the bidder's sale objectives, the bidder may be willing to pay a higher price than the bidder's previous high bid. The ability for both the bidder and the consignor to be remote from the auction facility also provides the ability for a consignor to represent his items to be auctioned at multiple concurrent auctions and represents an opportunity for both the consignor and the bidder to significantly reduce travel costs.

### BRIEF SUMMARY

The remote consignor/bidder supplement for traditional live auctions that is presented within this disclosure (hereinafter referred to as “the remote consigner/bidder system” is a modular addition to the Remote Bidding Supplement for Traditional Live Auctions that is described in U.S. Pat. No. 6,813,612, the disclosure of which is incorporated by reference as if fully set forth herein. The Remote Bidding Supplement for Traditional Live Auctions of U.S. Pat. No. 6,813,612 provides the infrastructure for the following elements of the remote consignor/bidder supplemental for traditional live auctions of the present invention:
Instantaneous audio and video from the live auction site to the remote consignor and/or bidder that are the objects of the present invention;
Clerk System interface that allows the on-line system to be kept in synchronization with the physical onsite live Auctioneer;
Marquee System interface that announces to the on-site live Auctioneer incoming bids from a remote bidder;
Bidder System interface that allows a remote bidder to participate in the live auction event; and
Auction Messaging that provides the ability for the Auctioneer/Clerk to send text messages to a remote auction participant and for that selected remote auction participant to respond to the Auctioneer/Clerk.

The additions the remote consigner/bidder system brings to the Remote Bidding Supplement for Traditional Live Auctions of U.S. Pat. No. 6,813,612, include the following:
A remote consignor function and console is added that allows a remote consignor to participate in two modes:
   Message mode—In the message mode, the remote consignor simply responds to the Auctioneer and Clerk with the amount the remote consignor is willing to reduce the reserve price, the additional amount that is required to be added to the current high bid amount, or a signal that the consignor is willing to sell at the current high bid amount regardless of the reserve price.
   Negotiation mode—In the negotiate mode, the consignor has the same capabilities included in the message mode plus the ability to respond to the high bidder with the amount the consignor is willing to reduce the reserve price, the additional amount that is required to be added to the current high bid amount, or a decision on the bidders' last “negotiation offer.”
The following capabilities are added to the Bidder System of the Remote Bidding Supplement for Traditional Live Auctions of U.S. Pat. No. 6,813,612:
   Message mode—the bidder simply responds to a message indicating the amount required to purchase the item at that time.
   Negotiation mode—In addition to the message mode capabilities, the bidder is able to “counter offer” and thus enter a negotiation directly with the remote consignor.
The Marquee System of the Remote Bidding Supplement for Traditional Live Auctions of U.S. Pat. No. 6,813,612 is updated to display that the consignor is willing to sell at the high price or the new amount required for purchase. FIG. 5 and FIG. 8 illustrate an updated Marquee System display in negotiation and messenger modes of the present invention.

While the remote consigner/bidder system is preferably used to supplement the functions of the Remote Bidding Supplement for Traditional Live Auctions of U.S. patent application Ser. No. 09/866,191, it also can be used as a stand alone system when there are no remote bidders.

### BRIEF DESCRIPTION OF THE SEVERAL VIEWS OF THE DRAWING

FIG. 1 illustrates a system overview of remote consignor/bidder system.

FIG. 2 illustrates the initial program flow of the system of FIG. 1.

FIG. 3 illustrates the logon process and negotiation process flow of the system of FIG. 1.

FIG. 4 illustrates an exemplary Clerk System display in a negotiation mode within the system of FIG. 1.

FIG. 5 illustrates an exemplary consignor display in negotiation mode within the system of FIG. 1.

FIG. 6 illustrates an exemplary Marquee System display in a negotiation mode within the system of FIG. 1.

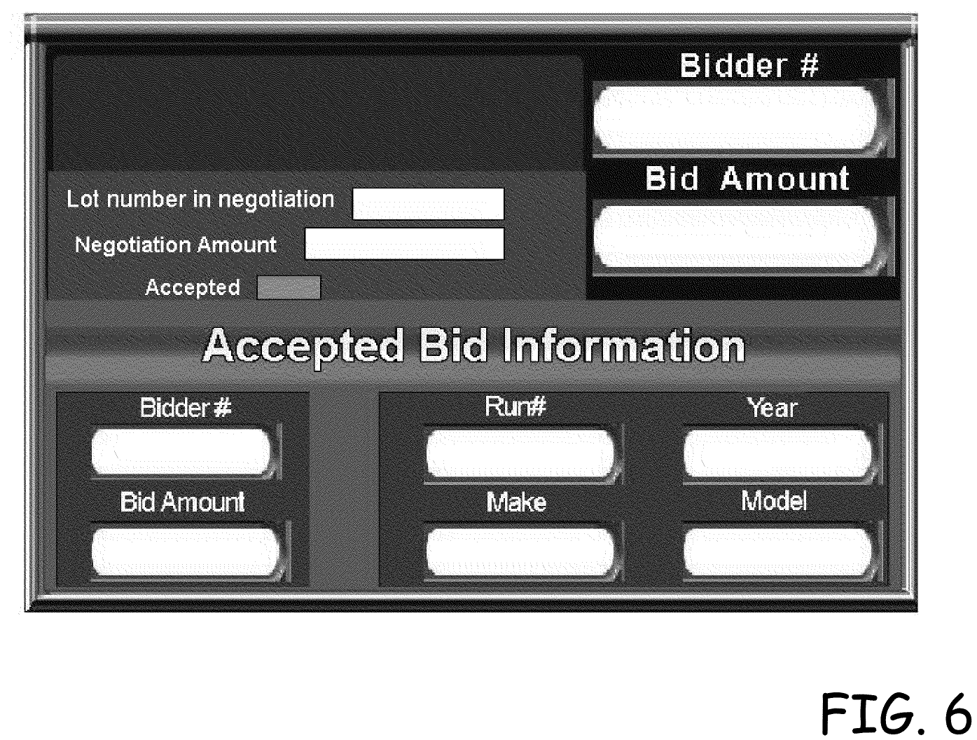

FIG. 7 illustrates an exemplary consignor console display in a messenger mode within the system of FIG. 1.

FIG. 8 illustrates an exemplary Marquee System display in a messenger mode within the system of FIG. 1.

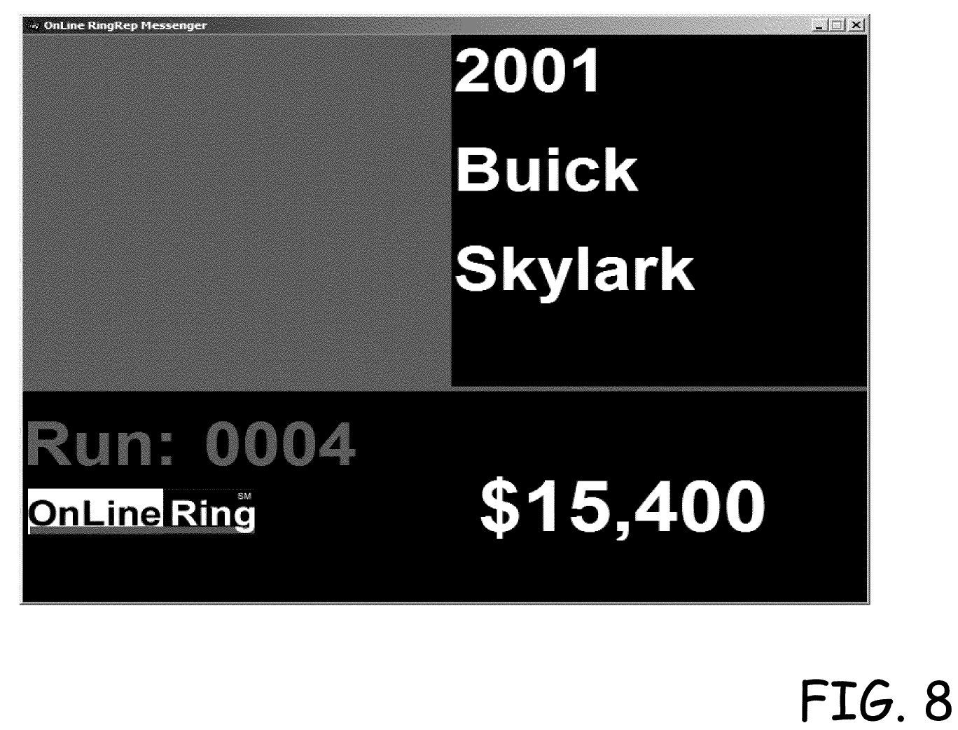

### DETAILED DESCRIPTION OF EMBODIMENTS OF THE INVENTION

Functional Overview

During a live auction, it may become necessary for a bidder to negotiate with a consignor to determine if a price can be agreed upon between these two parties. The consignor establishes a minimum price (floor price) that will be acceptable to the consignor for the item being auctioned. When the highest bid for an item does not meet the floor price, entering into a negotiation between the last high bidder and the consignor is one technique of furthering the probability of achieving a sale. The remote consignor/bidder system provides the ability for bidders and consignors to perform these negotiations in a number of situations:
(a) When the bidder and consignor are both present at the live auction, the negotiation is performed face-to-face and the results are entered by the auction Clerk;
(b) When either the bidder or the consignor (or both) is remote from the live auction (i.e., are not on-site), the remote consignor/bidder system provides the ability for the bidder and consignor to perform the negotiation through electronic data interchange with the results being reported back to the auction Clerk.

Once a negotiation is initiated, the interchange conducted between the bidder and consignor enforces an offer/response structure to ensure that each side is able to directly respond to a proposal with either an acceptance or a counter-offer. In addition, either the bidder or consignor can terminate the negotiation process at any time and return to the live auction (in person or via a remote access system).

When the consignor or bidder, or both, are remote from the auction site, an interface to the auction's hardware and software is required, such as the hardware and software disclosed in U.S. Pat. No. 6,813,612. For live auction floor bidders who wish to negotiate with a remote consignor, the auction system provides the hardware and software platform to facilitate this. These systems are directly connected to the remote consignor/bidder supplement for traditional live auctions, which acts as a message intermediary in the negotiation mode. The remote systems will vary in technology. The requirement is that they are all capable of executing the remote consignor/bidder supplement for traditional live auctions client software and are compatible with the auction's hardware and software.

Function Operation

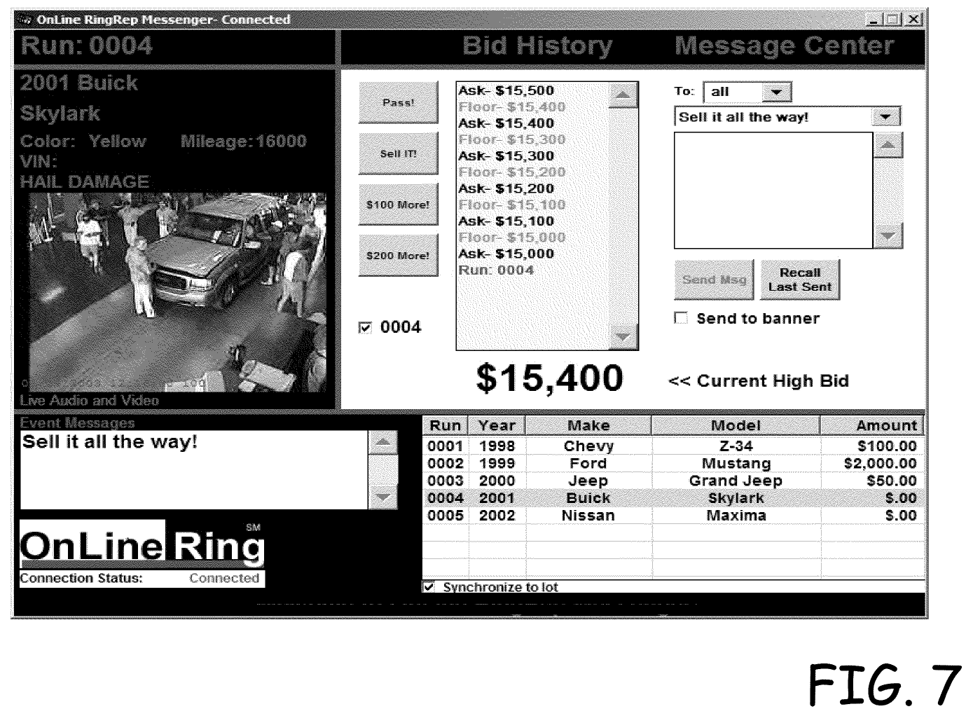

When the consignor and bidder functions are in normal auction mode, the systems work functionally the same as the Bidder System defined in the Remote Bidding Supplement for Traditional Live Auctions of U.S. Pat. No. 6,813,612. FIG. 7 illustrates an exemplary consignor console in the messenger mode of the present invention. When the negotiation is activated, the system activates the user interface on the respective devices to perform the negotiation mode enabled by the remote consignor/bidder supplement for traditional live auctions.

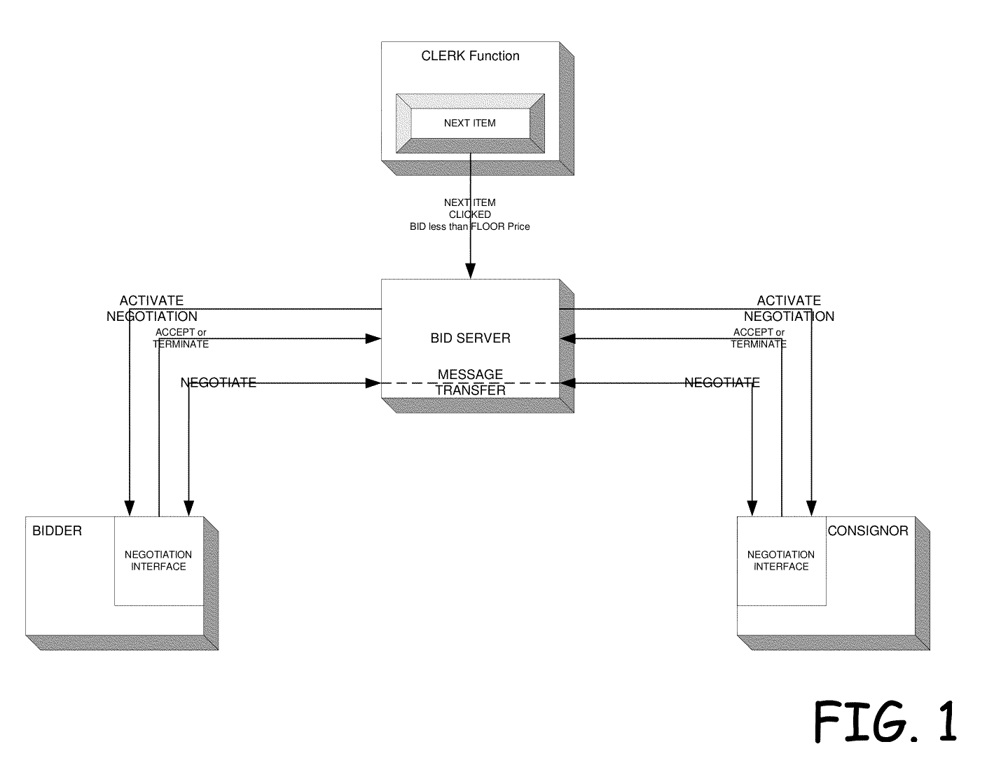

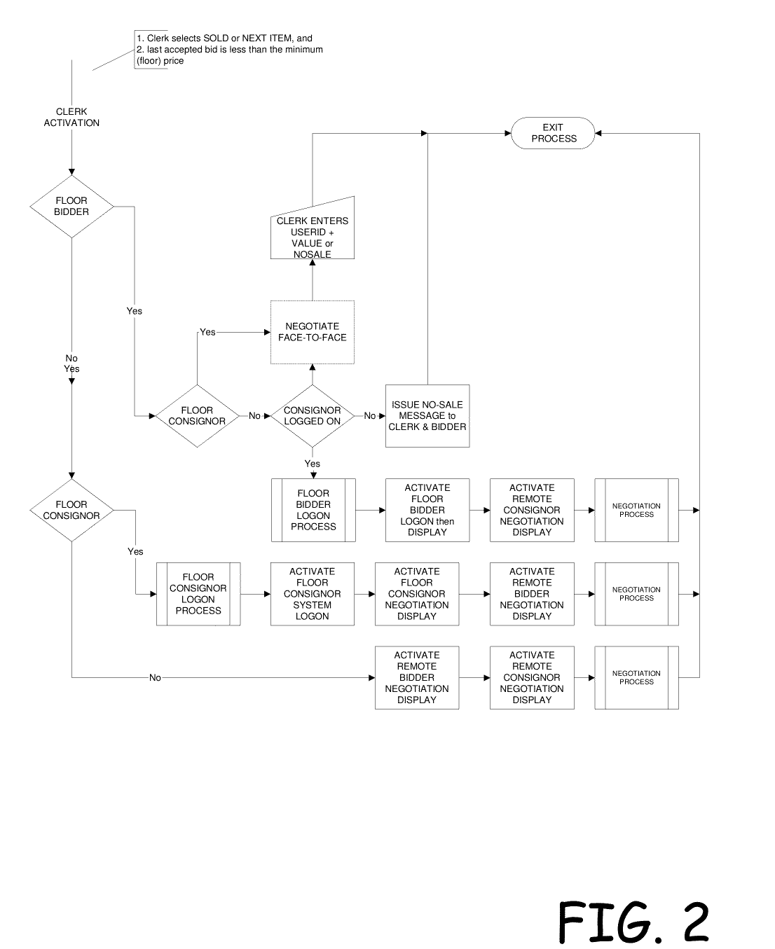

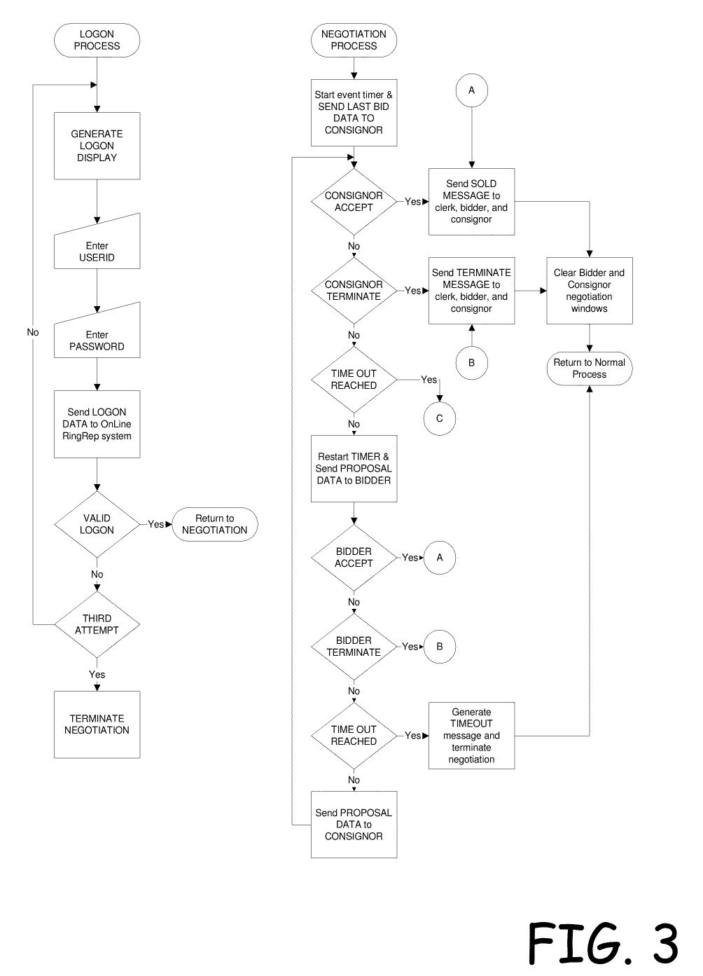

FIG. 1 illustrates a system overview of the remote consignor/bidder supplement for traditional live auctions; and FIG. 2 illustrates the initial program flow for negotiation activation of the system of FIG. 1; while FIG. 3 illustrates the logon process and negotiation process flow of the system of FIG. 1.

The function of the remote consignor/bidder supplement for traditional live auctions may be initiated by the Clerk System of the Remote Bidding Supplement for Traditional Live Auctions of U.S. Pat. No. 6,813,612. Once the negotiation is initiated, the remote consignor/bidder supplement for traditional live auctions acts as a message switch between the consignor and the bidder until their negotiation is complete. The criteria for initiation of the negotiation mode are:
1. The highest bid received for an item is less than the floor price established by the consignor prior to the start of the auction,
2. The Clerk System selects NEXT ITEM with or without selecting SOLD for the current item, and
3. The consignor is either located at the live auction or is logged onto the live auction through a remote system, such as the Remote Bidding Supplement for Traditional Live Auctions of U.S. Pat. No. 6,813,612.

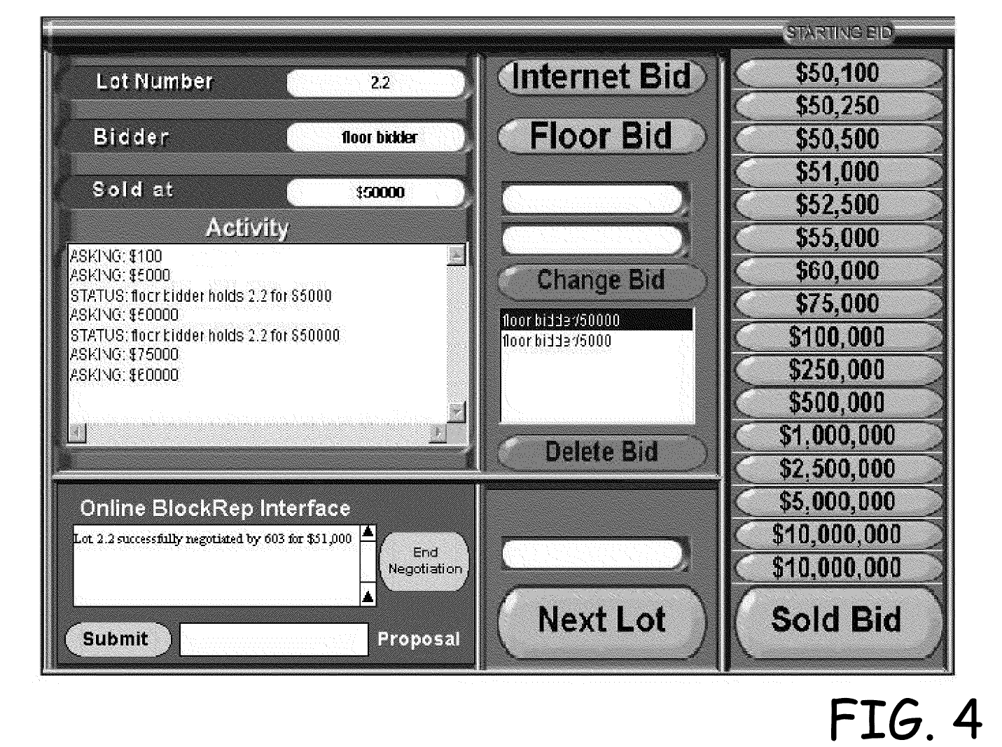

FIG. 4 illustrates an example of a Clerk System display in negotiation mode.

Consignor Options

The consignor is presented three options for each bid or counter-bid received from a bidder. These options include:
ACCEPT—the last bid (or counter proposal) received from the bidder is acceptable to the consignor and the consignor's auction item is considered sold by the consignor to the bidder. The remote consignor/bidder system notifies the Clerk System and the Bidder System that the item has been SOLD for a specified amount.
TERMINATE—the consignor does not wish to continue negotiations. The remote consignor/bidder system notifies the Clerk System and the Bidder System that a negotiation has been terminated by the consignor and the item is in a NO SALE.
NEGOTIATE—the consignor requests that an offer be forwarded to the bidder. For this case, the consignor is required to enter a proposed sale amount and click OK to activate the NEGOTIATE mode. The remote consignor/bidder supplement for traditional live auctions transmits the price proposal to the bidder.

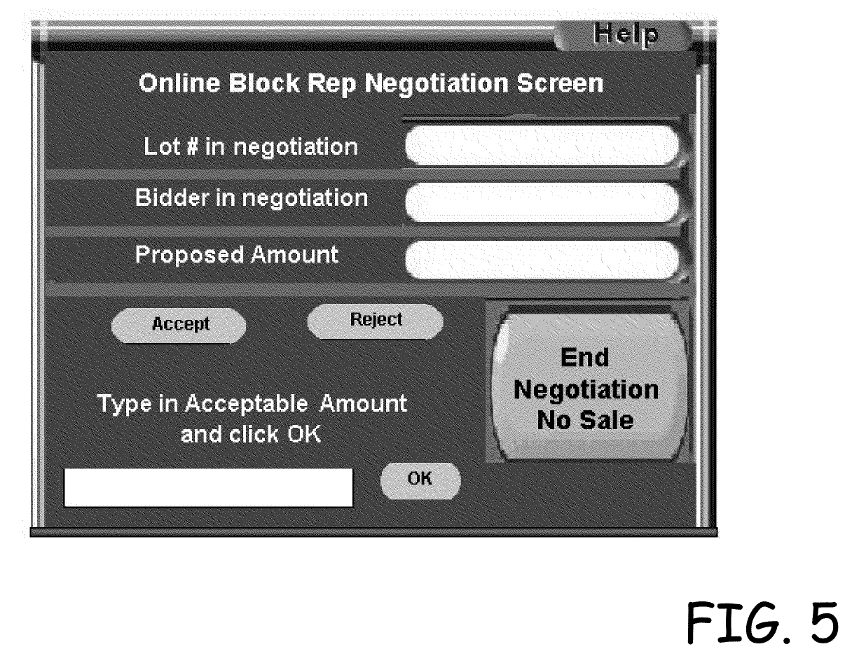

FIG. 5 illustrates an example of a consignor display during negotiation mode.

Bidder Options

The bidder has the same three options as the consignor:
ACCEPT—the last bid (or counter proposal) received from the consignor is acceptable to the bidder and the consignor's auction item is considered sold by the consignor to the bidder. The remote consignor/bidder system notifies the Clerk System and the Bidder System that the item has been SOLD for a specified amount.
TERMINATE—the bidder does not wish to continue negotiations. The remote consignor/bidder system notifies the Clerk System and the Bidder System that a negotiation has been terminated by the bidder and the item is in a NO SALE.
NEGOTIATE—the bidder requests that an offer be forwarded to the consignor. For this case, the bidder is required to enter a proposed sale amount and to click OK to activate the NEGOTIATE mode. The remote consignor/bidder system determines that the proposed value is within the credit limit of the bidder and then transmits the proposal to the consignor. If the bidder does not have sufficient credit for the proposed bid, the negotiation is placed in TERMINATE status by the remote consignor/bidder system with a message of INSUFFICIENT FUNDS sent to the Bidder System and Clerk System, and to the consignor.

Single Action Response Driven

For this process, each action by either the bidder or the consignor requires a response from the opposite party until an ACCEPT or TERMINATE function is recognized by the remote consignor/bidder system.

Time-Outs

The remote consignor/bidder system enforces a time out for each action initiated. The value is set by the on-site live auction to range from 15-60 seconds per action as a non-limiting example. An overall time limit for the negotiation is also set by the on-site live auction. This value can range from 1 minute to 3 minutes as a non-limiting example. These time limits are set prior to the live auction when the Clerk System function is activated. In an exemplary embodiment, the default values are set to 30 seconds per action and two minutes per negotiation. The default values are utilized if the Clerk System does not specify time out values when prompted by the system. The system prevents any other Clerk System activity while the time out values are input by the Clerk System. To set values, the Clerk System selects values from the two drop down menu boxes, one for per action and one for the negotiation mode. Increments for values in the drop down boxes are preset to 15 seconds.

Auction Lockout Option

The live auction is given the option (at software installation) to select the lockout status to be used during the auction:

1. Auction activity using the Clerk System function can continue during a negotiation, or

2. Auction activity using the Clerk System function is discontinued until the negotiation is complete.

For option (1), above, the system is set up to include NEGOTIATION STACKING. For the second option above, this function is not required, as the on-site live auction does not continue until each negotiation is complete.

Negotiation Stacking

If the on-site live auction selects the option to continue the auction during a negotiation, it is possible that additional negotiations for the same consignor may be required for successive items while a given negotiation is in progress. The remote consignor/bidder system stacks these negotiation requests in a queue and activates the next negotiation once the current negotiation is complete. Each consignor has a negotiation queue in the system such that multiple negotiations can be stacked for as many consignors as necessary to allow for conditions created by the time outs established by the auction coupled with the speed with which items are auctioned during the normal bidding process. A similar stacking process is used from the bidder's perspective.

This feature is also required for bidders and consignors who attend multiple simultaneous auctions via remote interfaces.

Consignor Not Logged In

If a consignor is not logged into the on-site live auction (defined by the auction as a remote consignor prior to the auction) at the time a negotiation mode is requested, the remote consignor/bidder system recognizes the consignor as being unavailable, places a NO SALE status on the item and does not activate the negotiation.

Bidder Logged Out

Should the bidder log out of the live auction during a negotiation, the time-out feature recognizes this condition and TERMINATEs the negotiation based on the time-out.

Consignor/Bidder Lockout Function

During a negotiation process, the bidder and consignor systems used for the negotiation are locked out from the normal bidding activity if the on-site live auction is continued during negotiations.

Consignor/Bidder Notification

The consignor and bidder are notified of a negotiation mode by the activation of a ‘user interface’ on the display of their respective systems. The remote consignor/bidder system recognizes the highest bid received as the first proposed bid to the consignor. The consignor window, therefore, initially includes the ACCEPT, TERMINATE, and NEGOTIATE options and is the first system that must respond.

Auction Setup

The remote consignor/bidder system requires data structures to be established by the live auction as part of the data submitted to control the processing of each consignor item through the on-site live auction process. This data includes:

1. Consignor ID included in the item data in the specified field. If a negotiation mode is required, this ID is used to activate the consignor's system interface.

2. Floor price included in the item data in the specified field. A blank field denotes any price is acceptable for this item, therefore, no negotiation is possible (bid value would always exceed the floor price of blank=0)

3. The user file created by the live auction and uploaded to the remote consignor/bidder system prior to the live auction requires that the live auction define whether or not each consignor will be in attendance (either at the auction or via a remote system). If the consignor is defined as not in attendance, no negotiation modes are initiated for that consignor. The remote consignor/bidder system checks current logins to the live auction from remote consignors/bidders to determine if the consignor is currently logged in to the auction before checking the availability status in this table.

System Structure

The structure of the remote consignor/bidder system allows the following consignor/bidder interfaces:

1. The normal structure for the bidder and consignor to negotiate, as necessary, on an item-by-item basis as the live auction progresses through the item list.

2. A multiple auction consignor userID/password can be established for a consignor who requires negotiation mode capability for simultaneous auctions. This requires the Negotiation Stacking feature previously described.

3. A multiple auction bidder userID/password can be established for a bidder who requires negotiation capability for simultaneous auctions. This requires the Negotiation Stacking feature previously described.

4. The system preferably allows up to five (5) consignor userID/password combinations to be linked (to a master consignor userID/password) together in a ring sequence to allow the next negotiation for that master consignor to go to the first available consignor representative.

Floor Bidder/Remote Consignor

For this condition, the on-site live auction provides a Bidder System at the live auction that is initially logged on by the on-site live auction as the bidder negotiation mode system. When a negotiation is activated, the remote consignor/bidder system automatically brings up a loon window that requires the floor bidder to enter a userID and password. If accepted, the bidder negotiation mode window is generated. If not accepted after three tries, the remote consignor/bidder system identifies the bidder as not available and terminates the negotiation as a NO SALE condition.

Remote Bidder/Remote Consignor

The negotiation process is conducted as previously described.

Remote Bidder/Floor Consignor

For this condition, the system referenced above for Floor Bidder/Remote Consignor is activated for a consignor login with the same conditions as stated previously.

Floor Bidder/Floor Consignor

Negotiation is conducted face-to-face. The result can be entered via the normal Clerk System SOLD function with capture of the floor bidder ID.

What is claimed is:

1. A method for enabling direct negotiations between two entities in an auction system in which items are auctioned off in a particular window of time, comprising the actions of:
streaming a live feed from a system operating at a live auction site to one or more remote entities, wherein one or more entities operates a bidding device that receives the live feed and transmits remote auction messages and bids for an item being auctioned at the live auction site;
accepting auction bids received by the system at the live auction site from onsite auction bidders and from remote entities operating a bidding device for the auctioned item;
presenting on a display located at the live auction site, auction bid information, including accepted auction bids and auction messages related to the auctioned item;
broadcasting auction bid information from the system to all remote entities for the auctioned item;
receiving at the system, messages and auction bids from one or more remote entities for the auctioned item;
enabling, after completion of a portion of a live auction earmarked for the sale of the auctioned item, a negotiation function that is integrated with the system and that enables a time period that is commensurate with the window of time for direct price negotiations between remote auction entities, wherein one entity is a consignor and the other entity is a high bidder for the auctioned item.

2. A method implemented within an auctioning system for enabling direct negotiations between consignors and bidders within a traditional-style live, on-line auction system in which remote entities and local entities can participate in the live auction and in which an audio/video feed is provided to the remote entities and, such that upon the conclusion of the bidding for a particular item, the method comprises the actions of:
enabling a negotiation mode that is integrated with the auctioning system for enabling a limited time window for direct price negotiations between auction consignors and auction bidders for one or more unsold consignor items after completion of a portion of the live auction earmarked to the sale of said one or more consignor items, the negotiations including offers, acceptances, counter-offers or rejections being subjective to response time constraints individually for each such operation.
